(19) United States
(12) Patent Application Publication
(10) Pub. No.: US 2009/0287536 A1
(43) Pub. Date: Nov. 19, 2009

(54) METHOD FOR DETERMINING CONSUMER PURCHASE BEHAVIOR

(76) Inventor: Michael P. Sheng, Schaumburg, IL (US)

Correspondence Address: CARDINAL LAW GROUP, Suite 2000, 1603 Orrington Avenue, Evanston, IL, 60201, US

(21) Appl. No.: 12/121,487

(22) Filed: May 15, 2008

(51) Int. Cl. G06Q 10/00

(52) U.S. Cl. 705/10

(57) ABSTRACT

Disclosed is a method for determining consumer purchasing behavior by corresponding received transaction data and received electronic payment data at a purchasing behavior node. The correspondence between the received transaction data and the received electronic payment data can be determined using payment and purchase amounts with timestamps in the received transaction data and received electronic payment data. If the timestamps are unavailable, the correspondence can be determined using the order or sequence of the purchases and transactions. The purchasing behavior node links data from the electronic payment data with data from the received transaction data. The linked data provides valuable information on how specific consumers are spending their money.

### BACKGROUND

Accurate consumer purchasing behavior data is a valuable resource in advertising and marketing. Different types of businesses such as retail companies, manufacturing companies, the government and service providers covet consumer purchasing behavior data because the data enables these entities to efficiently use their advertising resources by targeting individuals who are most likely to respond positively to their advertising and marketing.

Using consumer panel data and consumers surveys are well-known techniques for collecting consumer purchasing behavior data. Companies such as Information Resources Inc. (IRI) and ACNielsen collect data from sample households. ACNielsen, for example, uses a research tool, Homescan, where sample households track and report all of their grocery and retail purchases. Purchasing patterns can be calculated for household demographics through tools such as Homescan. Consumer panels, however, have several built-in-biases because the data reflects only the people willing to participate in such panels. Moreover, the sample data may not be an accurate representation of the demographic that the sample data is attempting to depict.

Another technique used for collecting consumer purchase behavior data is having consumers enroll in a frequent shopper program. In these programs, the retailers collect purchase behavior data and a third party will combine the frequent shopper data from the different retailers to create consumer data views. Consumers agree to enroll in these programs in exchange for some sort of benefit such as discounts or rewards. These frequent shopper programs are limited in reach and scale, however, because the data produced depends on consumers who agree to enroll in such a system and also depend on retailers that implement such programs. Moreover, frequent shopper programs are expensive for retailers because the retailers need to provide incentives for the customers to use the program as well as pay for the costs associated with third party analysis and the costs for implementing different prices for different customers depending on whether or not the customer is enrolled in the frequent shopper program. Frequent shopper programs are also expensive because of the requirement of physical infrastructure investments such as the machines needed to process frequent shopper cards.

What is needed is the ability to obtain large data sets of actual consumer purchasing behavior data for specific individuals without requiring consumer registration. Retailers would realize cost savings because the retailers would no longer need to implement the frequent shopper programs. Biases in the results would be removed because the data would not depend on consumers who enroll in the consumer panel or the frequent shopper program. The potential for acquiring large data sets could enable use by the government for the census. Actual consumer purchasing behavior data for specific individuals is a valuable resource for targeted advertising. Targeted advertising and marketing via different means such as direct mail, television, and internet that incorporated the actual purchasing behavior data would be more efficient and profitable than current advertising and marketing schemes.

### SUMMARY

One aspect of the present invention provides a method for determining consumer purchasing behavior. The method comprises receiving transaction data at a purchasing behavior node, receiving electronic payment data at the purchasing behavior node, determining whether the received transaction data corresponds to the electronic payment data at the purchasing behavior node and linking the received transaction data and the received electronic payment data based on the determination at the purchasing behavior node.

Another aspect of the present invention provides a method for determining consumer purchasing behavior. The method comprises receiving transaction data at purchasing behavior node; wherein the received transaction data includes consumer telephone number, determining whether the received transaction data corresponds to a telephone number database at the purchasing behavior node and linking the received transaction data and the telephone number database based on the determination at the purchasing behavior node.

### BRIEF DESCRIPTION OF DRAWINGS

The present invention is illustrated by the accompanying drawings of various embodiments and the detailed description given below. The drawings should not be taken to limit the invention to the specific embodiments but are for explanation and clarity. The detailed description and drawings are merely illustrative of the invention rather than limiting, the scope of the invention being defined by the appended claims and equivalents thereof. The foregoing aspects and other attendant advantages of the present invention will become more readily appreciated by the detailed description taken in conjunction with the accompanying drawings.

FIG. 1A is a block diagram for a background of a preferred embodiment of the present invention.

FIG. 1B is a block diagram for a preferred embodiment of the present invention.

FIG. 2 is a flow chart for a preferred embodiment of the present invention when a timestamp is available.

FIG. 3 is a flow chart for an alternative embodiment of the present invention when a timestamp is unavailable.

FIGS. 4-5 are block diagrams for an alternative embodiment of the present invention when electronic payment data is unavailable.

### DETAILED DESCRIPTION OF THE INVENTION

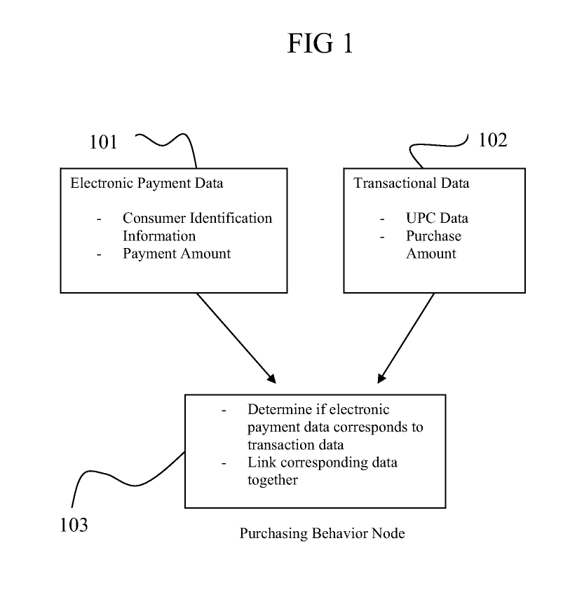

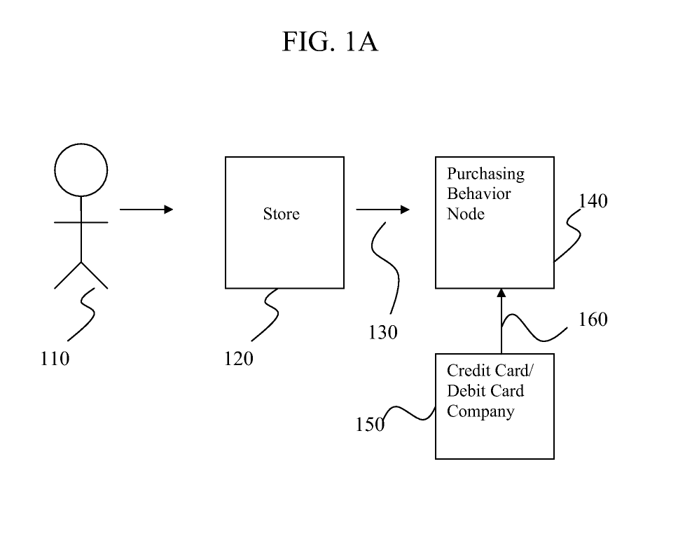

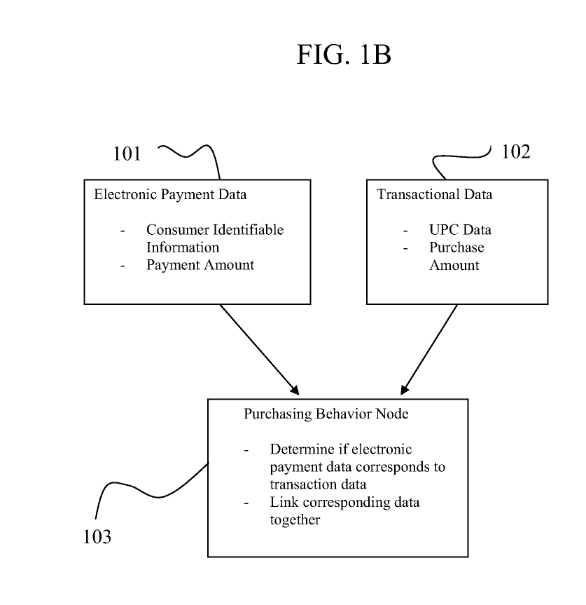

FIG. 1A illustrates a system for the implementation of various embodiments of the present invention. At FIG. 1A, a consumer (110) conducts an electronic purchase at a store (120), such as a brick and mortar retail location or a retail website. Data from the store is communicated (130) to the purchasing behavior node (140). The communication is implemented through available communication techniques. The communication medium is wired or wireless and the data is transferred over a communication network. Data from the credit card and debit card companies (150) is also communicated (160) to the purchasing behavior node in a similar way to the data transferred from the store to the purchasing behavior node. The purchasing behavior node has computers to process and store the data from the store and from the credit card and debit card companies. Those with ordinary skill in the art will appreciate that the present invention can be implemented in a variety of systems and system architectures and is not limited to the system illustrated in FIG. 1A.

FIG. 1B illustrates one embodiment of a method for determining consumer purchasing behavior. In FIG. 1B, a purchasing behavior node (103) receives electronic payment data (101) and transaction data (102). The electronic payment data (101) may be data from various credit card or debit card companies and includes information that identifies a consumer as well as a payment amount. The information that identifies the consumer may be the consumer's name, address or some other identifying attribute. The transaction data (102) may be from a specific retailer location and includes UPC data for the products purchased as well as a purchase amount.

At the purchasing behavior node (103), the received electronic payment data, filtered by the specific retail location, is compared to the received transaction data to determine if there is a correspondence between the received electronic payment data and the received transaction data. The corresponding data is linked together so that the data from the electronic payment data such as the consumer's name or address is associated with the UPC data that the consumer purchased. The linked corresponding data can be stored at the purchasing node or at another location.

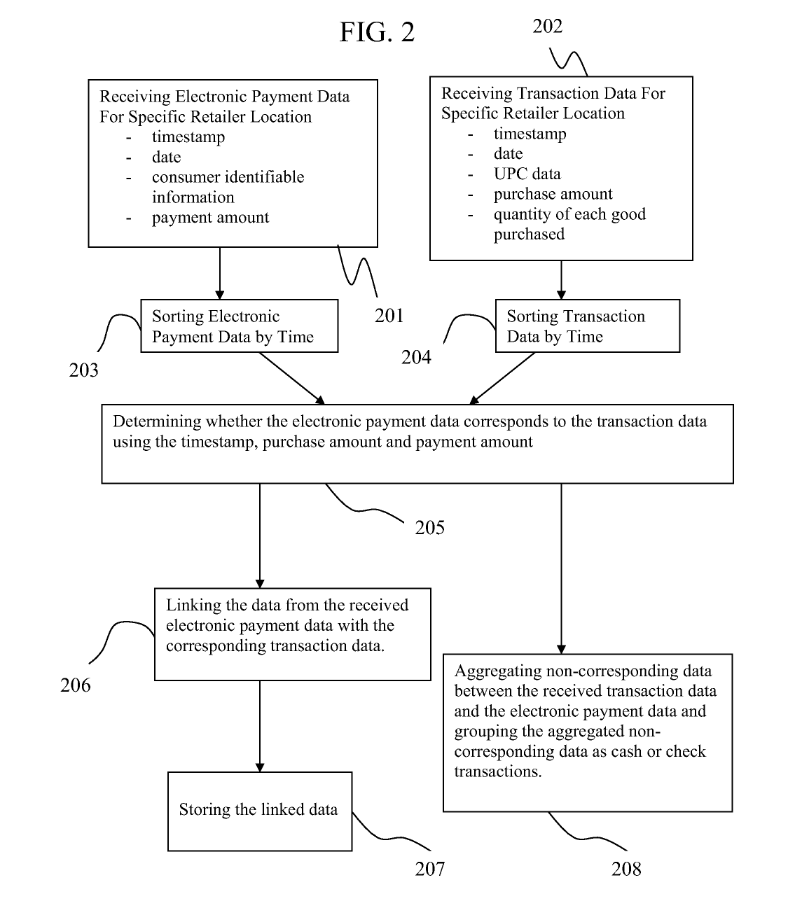

Determining whether the received electronic payment data corresponds to the received transaction data can be accomplished in multiple ways, in accordance with the present invention. FIG. 2 illustrates using timestamps for determining whether the received electronic payment data corresponds to the received transaction data. In FIG. 2, the received electronic payment data (201) can be received from various credit card and debit card companies or other electronic payment methods. The received electronic payment data is filtered by the specific retailer location. The received electronic payment data includes a date and timestamp for the payment along with the payment amount and the consumer identifiable information. The payment timestamp may be as precise as to the second. The payment amount may be as precise as to the cent.

The received transaction data (202) for the specific retailer location includes a date and timestamp for the purchase as well as the UPC data for the goods purchased, the UPC quantity data, and the purchase amount. The purchase timestamp may be as precise as to the second. The purchase amount may be as precise as to the cent.

Both the received electronic payment data (201) and the received transaction data (202) are sorted by time (203 and 204) using, respectively, the payment timestamp or the purchase timestamp. At 205, the purchasing behavior node (103) determines whether there is a correspondence between the received electronic payment data and the received transaction data. In one embodiment the determination is made by comparing the payment timestamp and payment amount with the purchase timestamp and the purchase amount. A correspondence is determined when the payment timestamp is equal to the purchase timestamp and if the purchase amount is equal to the payment amount.

At 206, the corresponding data is linked together so that data from the received electronic payment data, such as the consumer's name or address is associated with data from the received transaction data such as the UPC data for the purchased goods. At 207, the linked data is stored. In one embodiment, the linked data is stored at the purchasing behavior node or at another location.

At 205, the purchasing behavior node determines whether some of the received electronic payment data does not correspond with the received transaction data. Data may not correspond for various reasons such as, for example, the consumer using cash or a gift card for the purchase. In this case, there will be no record of the payment in the electronic payment data. At 208, the non-corresponding data is aggregated and grouped together as cash or check transactions.

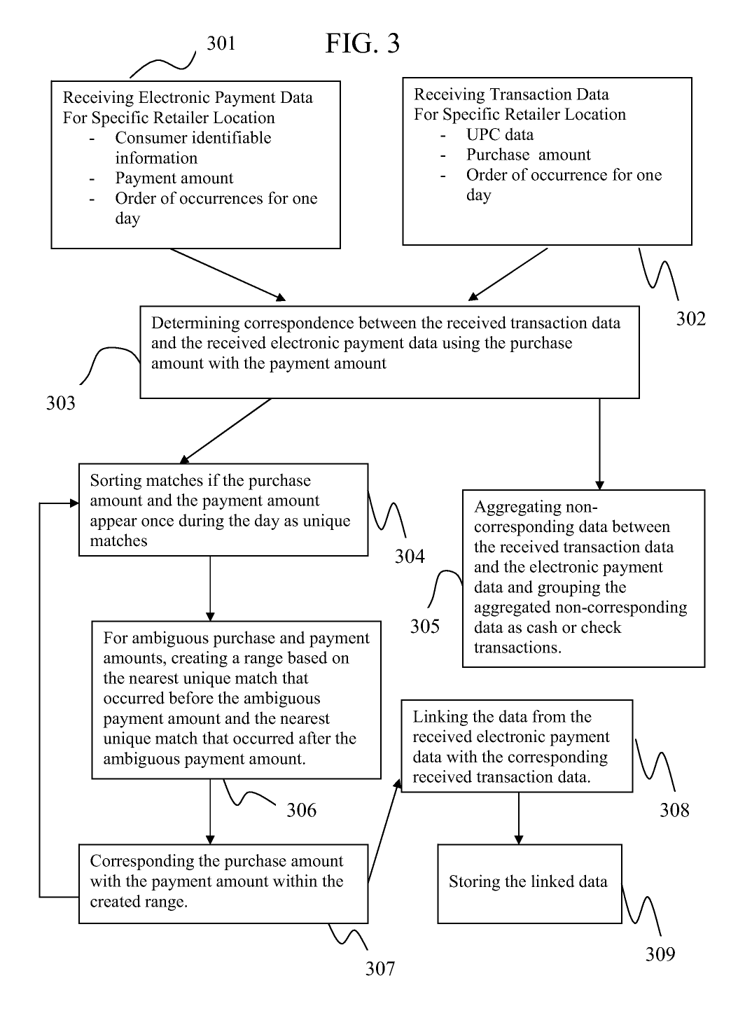

FIG. 3 illustrates another embodiment of a method for determining correspondence between the received electronic payment data and the transaction data. In this embodiment, a correspondence between the received electronic payment data and the transaction data is determined when timestamps are unavailable. In FIG. 3, the received electronic payment data (301), filtered by the specific retailer location includes the payment amount, consumer identifiable information, and an order (or sequence) of payments for an entire day. Although a timestamp may not always be available, the order or sequence of the occurrences of the payments is available. The received transaction data (302) of the specific retailer location in this embodiment includes the purchase amount, the UPC data of the goods purchased, the UPC quantity data, and an order (or sequence) of the purchases for the entire day for the specific retailer location.

At 303, the purchasing behavior node determines if there is correspondence between the received electronic payment data and the received transaction data. If during the entire day, there is a single specific payment amount that matches a single specific purchase amount, then there is a unique match (304), and there is a correspondence for these respective transactions. The received electronic payment data and the received transaction payment data is compared so that all the unique matches for the day are found (304).

However, there may be situations when there are multiple payment amounts and multiple purchase amounts that have the same total. For instance, there may be two payments and two purchases on a single day where the amount for all four transactions is $18.34. In this case, it is ambiguous as to which payment corresponds with which purchase. The problem of having ambiguous data is solved at 306. The nearest unique match before the ambiguous payment amount and the nearest unique match after the ambiguous payment is identified, and the two nearest unique match end points are used to create a range (306). Unique matches for the ambiguous amounts are identified (307) between the created range to determine the rest of the correspondences between the received electronic payment data and the received transaction data. The process of identifying unique matches is repeated until all possible unique matches are found and a single pass through the data does not determine any more matches.

At 308, for the corresponding data, the data from the received electronic payment data such as the consumer's name or address is linked with the data from the received transaction data such as the UPC data for the consumer's purchases. In one embodiment, the purchasing behavior node stores the linked data (309). The purchasing behavior node determines (304) whether at least one of the received electronic payment does not correspond with the received transaction data. The non-corresponding data is aggregated and grouped as check, gift card or cash transactions (305).

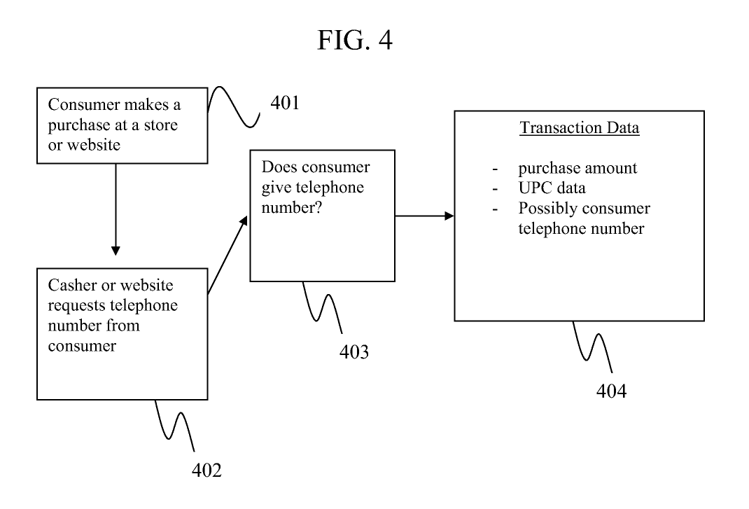

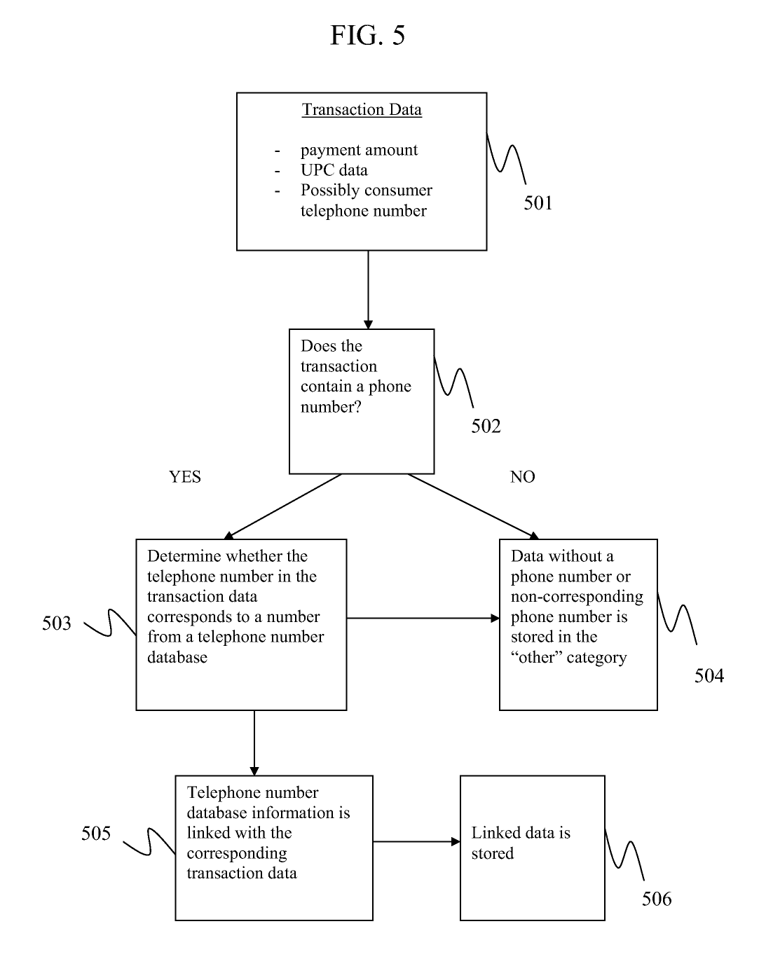

FIGS. 4-5 illustrate a flow chart for another method of determining consumer purchasing behavior in accordance with the present invention. In this embodiment, consumer purchasing behavior is determined when the electronic payment data is unavailable. In FIG. 4, the consumer purchases items at a cashier or via a checkout cart on a website (401). The cashier or website then requests the consumer's telephone number at checkout (402). Currently, stores and websites often request telephone numbers at the checkout so the request would not be that intrusive nor necessarily depart significantly from a checkout procedure that does not make a request for a consumer's telephone number.

The consumer has an option of providing or not providing his telephone number to the retailer (404). If the consumer provides his telephone number, that data is stored in the transaction data of the retail location along with the purchase amount, the UPC data for the purchases, a date, and possibly a purchase timestamp (405).

Referring to FIG. 5, the purchasing behavior node receives the transaction data from the retailer (501). The received transaction data is sorted by whether or not the received transaction data has a telephone number (502). If there is no telephone number for the purchase in the received transaction data, the purchase is grouped into an “other” category (504).

If the transaction data includes a telephone number, the telephone number is compared to a national directory of telephone numbers (503). The purchasing behavior node determines that there is a correspondence between the received transaction data and the data from the national directory if there is a match between the telephone number from the received transaction data and the telephone number from the national directory. For the corresponding data, information from the national directory such as the consumer's name or address is linked with data from the received transaction data such as the UPC data of the consumer's purchases and the purchase amount (505). In one embodiment, the purchasing behavior node can store the linked data (506).

In this embodiment, the method of determining consumer purchasing behavior does not require receipt of electronic payment data. In another embodiment, the consumer purchasing behavior can also be obtained from cash or check transactions where the consumer provides a telephone number for any type of transaction, not just the transactions that involve electronic payments. In another embodiment, the purchasing behavior node is implemented by the retailer itself since no other data other than the national telephone database is needed.

The linked data produced by the different embodiments of the invention is a valuable resource because the data shows how specific people are spending their money. This information enables companies to intelligently advertise and market their products because the companies have actual data of who is buying what from where; therefore, this leads to more efficient and effective use of advertising and marketing resources by the companies. The invention is also well-suited for large multi-store chains such as Wal-Mart or Target. The purchasing behavior node can aggregate data from multiple stores of the same retailer before determining correspondences. This provides useful, additional consumer research information for the large multi-store chains.

Although the invention has been described with reference to these preferred embodiments, other embodiments could be made by those in the art to achieve the same or similar results. Variations and modifications of the present invention will be apparent to one skilled in the art based on this disclosure, and the present invention encompasses all such modifications and equivalents.

1. A method for determining consumer purchasing behavior, the method comprising:
receiving transaction data at a purchasing behavior node;
receiving electronic payment data at the purchasing behavior node;
determining whether the received transaction data corresponds to the electronic payment data at the purchasing behavior node; and
linking the received transaction data and the received electronic payment data based on the determination at the purchasing behavior node.

2. The method of claim 1, wherein the received transaction data includes UPC data and purchase amount; and wherein the received electronic payment data includes consumer identifiable information and payment amount.

3. The method of claim 1, further comprising: storing the linked data at the purchasing behavior node.

4. The method of claim 1, wherein determining whether the received transaction data corresponds to the electronic payment data at the purchasing behavior node further comprises:
aggregating non-corresponding data between the received transaction data and the electronic payment data; and
grouping the aggregated non-corresponding data as cash or check transactions.

5. The method of claim 1, wherein the received transaction data includes a purchase timestamp;
wherein the received electronic payment data includes a payment timestamp;
wherein determining whether the received transaction data corresponds to the electronic payment data at the purchasing behavior node further comprises:
using the payment timestamp, the purchase timestamp, the payment amount and the purchase amount to correspond the received transaction data to the electronic payment data.

6. The method of claim 4, wherein the receiving electronic payment data further comprising:
aggregating the electronic payment data from a plurality of credit card companies, debit card companies and electronic payment sources; and
filtering the aggregated electronic payment data by a retail location.

7. The method of claim 1, wherein the received transaction data includes the received transaction data for an entire day in order of occurrence; and the received electronic payment data includes the received electronic payment data for the entire day in order of occurrence.

8. The method of claim 7, the determining whether the received transaction data corresponds to the electronic payment data at the purchasing behavior node further comprising:
corresponding the received transaction data and the received electronic payment data using the purchase amount with the payment amount;
sorting unique matches if the corresponding purchase amount and the payment amount appear once during the day and if the purchase amount and the payment amount are ambiguous by appearing multiple times during the day,
creating a range based on the nearest unique match that occurred before the ambiguous payment amount and the nearest unique match that occurred after the ambiguous payment amount; and
corresponding the purchase amount with the payment amount within the created range until the purchase amount and payment amount are not ambiguous.

9. A method for determining consumer purchasing behavior, the method comprising:
receiving transaction data at a purchasing behavior node; wherein the received transaction data includes consumer a telephone number;
determining whether the received transaction data corresponds to a telephone number database at the purchasing behavior node; and
linking the received transaction data and the telephone number database based on the determination at the purchasing behavior node.

10. The method of claim 9, wherein the received transaction data includes UPC data.

11. The method of claim 9, further comprising:
storing the linked data at the purchasing behavior node.

12. The method of claim 9 further comprising:
aggregating non-corresponding data between the received transaction data and the telephone number database; and
grouping the aggregated non-corresponding data as other category.

13. A computer readable medium for determining consumer purchasing behavior, the computer readable medium comprising:
computer readable code for receiving transaction data at purchasing behavior node;
computer readable code for receiving electronic payment data at the purchasing behavior node;
computer readable code for determining whether the received transaction data corresponds to the electronic payment data at the purchasing behavior node; and
computer readable code for linking the received transaction data and the received electronic payment data based on the determination at the purchasing behavior node.

14. The computer readable medium of claim 11, wherein the received transaction data includes UPC data and purchase amount;
wherein the received electronic payment data includes consumer identifiable information and payment amount.

15. The computer readable medium of claim 13, further comprising computer-readable code for storing the linked data at the purchasing behavior node.

16. The computer readable medium of claim 13, wherein the computer readable code for determining whether the received transaction data corresponds to the electronic payment data at the purchasing behavior node further comprises:
computer readable code for aggregating non-corresponding data between the received transaction data and the electronic payment data; and
computer readable code for grouping the aggregated non-corresponding data as cash or check transactions.

17. The computer readable medium of claim 13, wherein the received transaction data includes a purchase timestamp; wherein the received electronic payment data includes a payment timestamp; and wherein the computer readable code for determining whether the received transaction data corresponds to the electronic payment data at the purchasing behavior node further comprises:
computer readable code for using the payment timestamp, the purchase timestamp, the payment amount and the purchase amount to correspond the received transaction data to the electronic payment data.

18. The computer readable medium of claim 16, wherein the computer readable code for receiving electronic payment data further comprises:
computer readable code for aggregating the electronic payment data from a plurality of credit card and debit card companies; and
computer readable code for filtering the aggregated electronic payment data by a specific retail location.

19. The computer readable medium of claim 13, wherein the received transaction data includes the received transaction data for an entire day in order of occurrence; and the received electronic payment data includes the received electronic payment data for the entire day in order of occurrence.

20. The computer readable medium of claim 19, wherein the computer readable code for determining whether the received transaction data corresponds to the electronic payment data at the purchasing behavior node further comprises:
computer readable code for corresponding the received transaction data and the received electronic payment data using the purchase amount with the payment amount;
computer readable code for sorting unique matches if the corresponding purchase amount and the payment amount appear once during the day and if the purchase amount and the payment amount are ambiguous by appearing multiple times during the day,
computer readable code for creating a range based on the nearest unique match that occurred before the ambiguous payment amount and the nearest unique match that occurred after the ambiguous payment amount; and
computer readable code for corresponding the purchase amount with the payment amount within the created range until the purchase amount and payment amount are not ambiguous.
